(19) United States
(12) Patent Application Publication
(10) Pub. No.: US 2020/0298593 A1
(43) Pub. Date: Sep. 24, 2020

(54) INKJET PRINTER

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 16/819,201

(22) Filed: Mar. 16, 2020

(30) Foreign Application Priority Data
Mar. 19, 2019 (JP) 2019-051819

(51) Int. Cl. B41J 11/00

(52) U.S. Cl. CPC B41J 11/002

(57) ABSTRACT

An inkjet printer is provided. The printing unit prints an image on a medium by ejecting an ink onto the medium while moving in the main scanning direction. The printing unit includes a carriage, an inkjet head, a fixing device (drying device), a left air supply part, an intermediate air supply part, a right air supply part, and an intake part. The intake part takes in air by suctioning gas on a lower side. The gas on the lower side includes, in addition to air, a solvent evaporated when drying the ink (also referred to as a solvent vapor), and a misted ink that is mist of the ink ejected from the inkjet head.

### CROSS REFERENCE TO RELATED APPLICATIONS

This application claims the priority benefit of Japanese Patent Application No. 2019-051819, filed on Mar. 19, 2019. The entirety of the above-mentioned patent application is hereby incorporated by reference herein and made a part of this specification.

### TECHNICAL FIELD

The present disclosure relates to an inkjet printer.

### DESCRIPTION OF THE BACKGROUND ART

Conventionally, inkjet printers that eject ink by an inkjet method are known. As such an inkjet printer, for example, Japanese Unexamined Patent Publication No. 2017-209983 (i.e., Patent Literature 1) discloses an inkjet printer that fixes ink by drying ink after the ink (UV instantaneous drying ink) is ejected from an inkjet head (inkjet head 120) to a medium (medium 50).

Patent Literature 1: Japanese Unexamined Patent Publication No. 2017-209983

### SUMMARY

In the inkjet printer disclosed in Japanese Unexamined Patent Publication No. 2017-209983, the ink solvent and the like is evaporated to dry the ink when fixing ink (ink layer formed on the medium) ejected from the inkjet head to the medium, but the evaporated solvent or the like may condense and adhere to an unintended location (device in an inkjet printer, etc.). Furthermore, a part of the ink ejected from the inkjet head may be scattered as ink mist (misted ink), and may adhere to an unintended location (device in an inkjet printer, etc.). As described above, in the inkjet printer disclosed in Japanese Unexamined Patent Publication No. 2017-209983, a part of ink ejected from the inkjet head (evaporated solvent, ink mist, etc.) may adhere to an unintended location.

The present disclosure has been made in view of the above points, and an object thereof is to prevent a part of ink ejected from an inkjet head from adhering to an unintended location.

In order to solve the above problems, an inkjet printer of the present disclosure includes, an inkjet head that ejects ink onto a medium through an inkjet method when moving relative to the medium in a predetermined direction, and an intake part that is disposed on the back side of the inkjet head in the predetermined direction and that takes in air while moving relative to the medium in the predetermined direction together with the inkjet head.

According to the above configuration, a part of the ink ejected from the inkjet head (evaporated component, ink mist, etc.) can be suctioned by the intake part, and the part of the ink can be prevented from adhering to an unintended location (specifically, location not desired by the user, the manufacturer of the inkjet printer, etc.).

The intake part may take in an evaporated component of the ink components ejected from the inkjet head onto the medium.

According to the above configuration, the evaporated component can be suctioned in by the intake part, and the evaporated component can be prevented from adhering to an unintended location.

The intake part may take in a misted ink mist of the ink ejected from the inkjet head.

According to the above configuration, the ink mist can be suctioned by the intake part, and the ink mist can be prevented from adhering to an unintended location.

The inkjet printer according to the present disclosure may further include a first air supply part that is disposed on the front side of the inkjet head in the predetermined direction and that supplies air toward the medium side while moving relative to the medium in the predetermined direction together with the inkjet head.

According to the above configuration, a part of the ink ejected from the inkjet head can be moved away from the inkjet head by the air supply from the first air supply part, so that a part of the ink can be guided to the intake part on the back side, and the part of the ink can be prevented from adhering to an unintended location.

The inkjet printer according to the present disclosure may further include a second air supply part that is disposed between the inkjet head and the intake part and that supplies air toward the medium side while moving relative to the medium in the predetermined direction together with the inkjet head, where the second air supply part and the intake part may be disposed adjacent to each other in the predetermined direction.

According to the above configuration, a part of the ink ejected from the inkjet head can be moved away from the inkjet head by the air supply from the second air supply part, and furthermore, a part of the ink can be taken in by the intake part on the immediately back side of the second air supply part, so that the part of the ink can be prevented from adhering to an unintended location.

The inkjet printer according to the present disclosure may further include a drying device that is disposed between the inkjet head and the intake part, and that moves relative to the medium in the predetermined direction together with the inkjet head to dry the ink ejected from the inkjet head onto the medium.

According to the above configuration, the air intake part is located on the back side of the drying device, so that the intake part can take in components evaporated from the ink by the drying device, and a part of the ink ejected from the inkjet head (evaporated component) can be prevented from adhering to an unintended location.

The ink may contain an energy ray absorbing component that absorbs energy rays and generates heat, the drying device may irradiate the ink ejected onto the medium with the energy rays to heat the energy ray absorbing component and dry the ink, and the intake part may take in a component evaporated when drying the ink.

When the ink contains an energy ray absorbing component as in the configuration described above, the ink solvent and the like evaporate all at once due to the irradiation of the energy ray, but the evaporated solvent and the like can be effectively taken in by the intake part. Thus, the intake part operates effectively when the ink contains an energy ray absorbing component.

The inkjet printer according to the present disclosure may further include a third air supply part that is disposed between the drying device and the intake part and that supplies air toward the medium side while moving relative to the medium in the predetermined direction together with the inkjet head; where the third air supply part and the intake part may be disposed adjacent to each other in the predetermined direction.

According to the above configuration, a part of the ink ejected from the inkjet head can be moved away from the drying device by the air supply from the third air supply part, and furthermore, a part of the ink can be taken in by the intake part on the immediately back side of the third air supply part, so that the part of the ink can be prevented from adhering to an unintended location.

The inkjet printer according to the present disclosure may further include a fourth air supply part that is disposed between the inkjet head and the drying device, and that supplies air toward the medium side while moving relative to the medium in the predetermined direction together with the inkjet head.

According to the above configuration, a part of the ink ejected from the inkjet head can be moved away from, for example, the inkjet head and the drying device by the air supply from the fourth air supply part, and the part of the ink can be prevented from adhering to an unintended location.

### Effects of Disclosure

According to the present disclosure, a part of the ink ejected from the inkjet head can be prevented from adhering to an unintended location.

### BRIEF DESCRIPTION OF THE DRAWINGS

FIG. 1 is an overall view of an inkjet printer according to one embodiment of the present disclosure.

FIG. 2 is a configuration view in a device main body.

FIG. 3 is a configuration view of a printing unit when viewed from below.

FIG. 4 is a cross-sectional view of a left air supply part and the like.

FIG. 5 is a block diagram showing a device configuration for air supply and air intake.

FIG. 6 is a block diagram of a control system in the device main body.

FIG. 7 is a configuration view of the device main body for explaining airflow and the like.

FIG. 8 is a configuration view of a printing unit according to a modified example.

FIG. 9 is a configuration view of a printing unit according to a modified example.

FIG. 10 is a configuration view of a printing unit according to a modified example.

FIG. 11 is a configuration view of a printing unit according to a modified example.

FIG. 12 is a configuration view of a printing unit according to a modified example.

### DESCRIPTION OF EMBODIMENTS

Hereinafter, an inkjet printer 10 according to an embodiment of the present disclosure will be described with reference to the drawings.

(Configuration of Inkjet Printer 10)

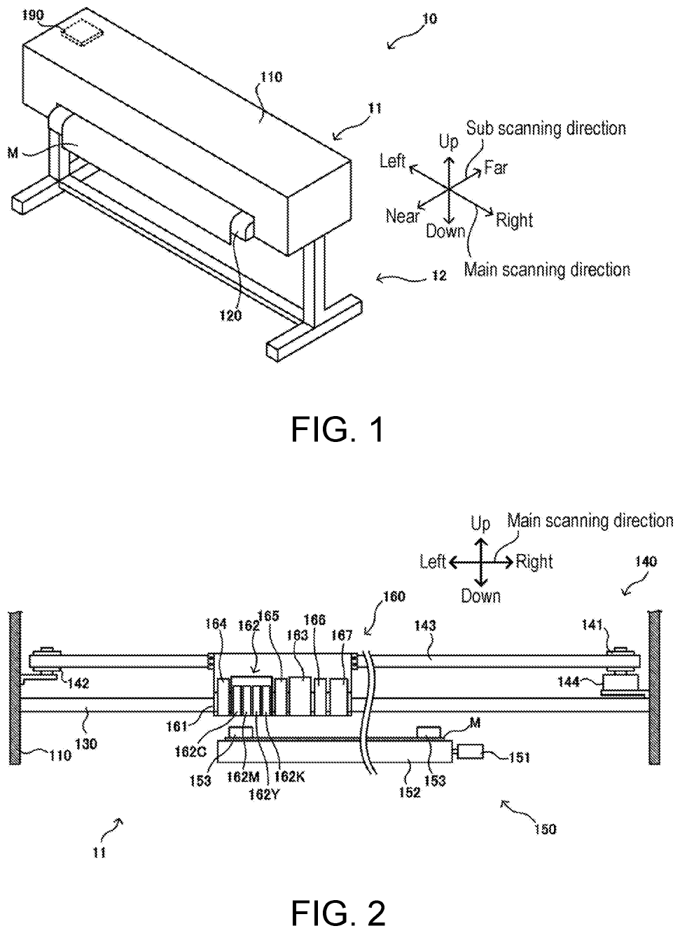

The inkjet printer 10 is configured as shown in FIG. 1, for example, and prints an image on a medium M by an inkjet method. The medium M is, for example, a sheet material such as paper or cloth. The inkjet printer 10 includes a device main body 11 and a mount 12. The device main body 11 is a part that prints an image on the medium M, and is supported by the mount 12 at an upper position away from the floor.

As shown in FIGS. 1 and 2, the device main body 11 includes a housing 110, a platen 120 (not shown in FIG. 2), a guide rail 130, a drive mechanism 140, a feed mechanism 150, a printing unit 160.

The housing 110 supports the platen 120 and interiorly accommodates the guide rail 130, the drive mechanism 140, the printing unit 160, and the like. The platen 120 supports the medium M. The guide rail 130 is extended in the left-right direction, that is, along the main scanning direction, and guides (guides) the movement of the printing unit 160 along the main scanning direction.

The drive mechanism 140 moves the printing unit 160 along the main scanning direction. The drive mechanism 140 includes a driving pulley 141, a driven pulley 142, a driving belt 143, and a driving motor 144.

The driving pulley 141 is disposed at the right end of the device main body 11. The driven pulley 142 is disposed at the left end of the device main body 11. The driving belt 143 is formed in a band shape and is wound around the driving pulley 141 and the driven pulley 142. The printing unit 160 (carriage 161 described later) is attached to the driving belt 143.

The driving motor 144 includes a stepping motor or the like, and rotates the driving pulley 141. This rotation causes the driving belt 143 to rotate, whereby the printing unit 160 moves along the main scanning direction.

The feed mechanism 150 is a mechanism for feeding the medium M in the sub scanning direction (direction orthogonal to the moving direction of the printing unit 160), which is the near-far direction. The feed mechanism 150 includes a driving motor 151, a driving roller 152, and a plurality of pinch rollers 153.

The driving motor 151 includes a stepping motor or the like, and rotates the driving roller 152. The driving roller 152 is accommodated in the platen 120 together with the driving motor 151. A hole is provided in the upper surface of the platen 120, and the driving roller 152 is exposed through the hole in the upper surface.

The driving roller 152 and the pinch roller 153 rotate with the central axis along the main scanning direction as a rotation axis. The driving roller 152 and the pinch roller 153 sandwich the medium M. As the driving roller 152 is rotated by the driving motor 151, the medium M is fed along the sub scanning direction.

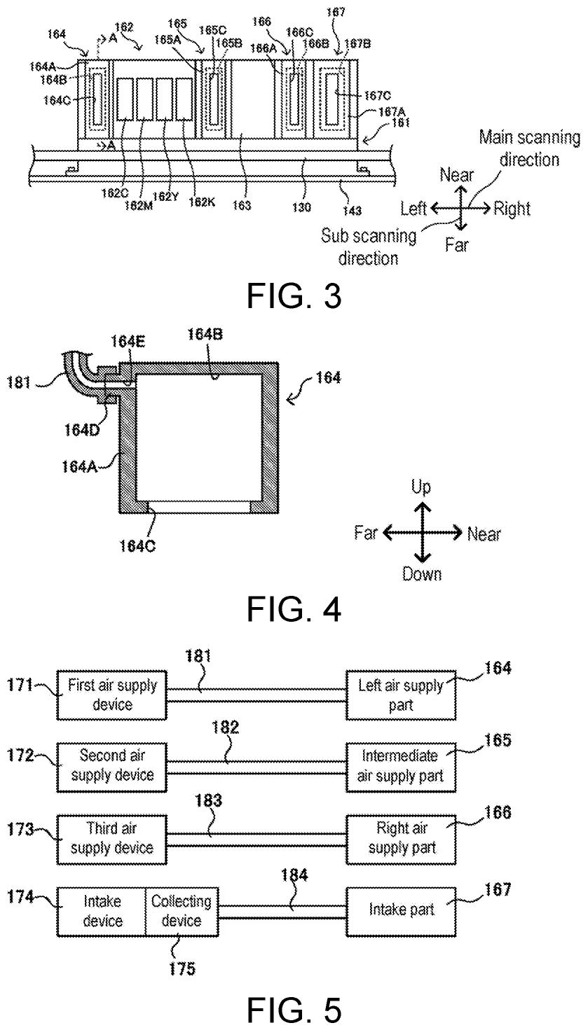

The printing unit 160 prints an image on the medium M by ejecting ink onto the medium M while moving in the main scanning direction. The printing unit 160 ejects ink when moving in the direction from the right to the left in FIG. 2 (advancing direction) in the main scanning direction. As shown in FIGS. 2 and 3, the printing unit 160 includes a carriage 161, an inkjet head 162, a fixing device (drying device) 163, a left air supply part 164, an intermediate air supply part 165, a right air supply part 166 and an intake part 167.

The carriage 161 is mounted with the inkjet head 162, the fixing device 163, the left air supply part 164, the intermediate air supply part 165, the right air supply part 166, and the intake part 167. The carriage 161 is attached to the driving belt 143, and the movement along the main scanning direction is guided by the guide rail 130. The carriage 161 moves in the main scanning direction by the rotation of the driving belt 143 of the drive mechanism 140, and thereby carries the inkjet head 162 and the like mounted on the carriage 161 in the main scanning direction (in other words, the printing unit 160 moves along the main scanning direction).

When printing an image, the inkjet head 162 ejects printing ink onto the medium M by an inkjet method (may be either a piezo method or a thermal head method).

The inkjet head 162 includes a head 162C that ejects cyan (C) ink (the head alone is also called an inkjet head. Hereinafter, the same applies to the head), and a head 162M that ejects magenta (M) ink. Furthermore, the inkjet head 162 includes a head 162Y that ejects yellow (Y) ink and a head 162K that ejects black (K) ink.

The device main body 11 has an ink supply mechanism (not shown), and ink is supplied to the heads 162C to 162K from a cartridge or an ink bottle attached to the device main body 11 through the ink supply mechanism. The ink cartridge, the ink supply mechanism, and the like may be mounted on the carriage 161.

Each ink ejected from the inkjet head 162 includes, for example, an instantaneous drying ink that instantaneously dries with ultraviolet lights. The instantaneous drying ink includes a solvent (water, solvent, SUV (solvent UV ink component), etc.) and an ultraviolet absorbent in addition to the pigment or dye. When such instantaneous drying ink is irradiated with ultraviolet lights, the ultraviolet absorbent absorbs the ultraviolet lights and generates heat, and the solvent is evaporated by the generated heat. Due to the evaporation of the solvent, the instantaneous drying ink is dried and fixed on the medium M.

The fixing device 163 includes an LED or the like that emits ultraviolet lights. The fixing device 163 may include an LED that emits light of a predetermined wavelength and a wavelength conversion unit that performs wavelength conversion of the light. The fixing device 163 is located on the right side of the inkjet head 162, and irradiates the ink ejected from the inkjet head 162 and landed on the medium M with ultraviolet lights from an LED or the like to dry and fix the ink on the medium M. The fixing device 163 can also be said to be a drying device for drying ink.

The left air supply part 164 to the right air supply part 166 sends out (exhales) gas (air herein) downward to supply air downward. The left air supply part 164 is located on the left side of the inkjet head 162, and the intermediate air supply part 165 is located between the inkjet head 162 and the fixing device 163. The right air supply part 166 is located between the fixing device 163 and the intake part 167.

As shown in FIGS. 3 and 4, the left air supply part 164 includes a main body 164A, an air chamber 164B, an air supply port 164C, a connecting part 164D, and a gas flow path 164E.

The main body 164A has a cubic shape, and interiorly includes a cubic-shaped air chamber 164B, and the air supply port 164C penetrating the main body 164A in the vertical direction is provided at the position of the lower surface (facing the medium side and facing downward). The air supply port 164C is extended in the sub scanning direction orthogonal to the main scanning direction, which is the moving direction of the printing unit 160. The air supply port 164C allows the air chamber 164B to communicate with the lower side of the left air supply part 164 (main body 164A).

The connecting part 164D is provided in a convex shape on the far surface (surface facing in the far side direction) of the main body 164A, and is connected to a first air supply pipe 181 to be described later. The gas flow path 164E extends in the near-far direction (sub scanning direction), penetrates the main body 164A and the connecting part 164D, and communicates the air chamber 164B with the first air supply pipe 181.

As will be described later, gas is supplied to the air chamber 164B via the first air supply pipe 181 and the gas flow path 164E. Thus, the air chamber 164B becomes a positive pressure, and the gas in the air chamber 164B is sent out toward the lower side of the left air supply part 164 from the air supply port 164C.

The intermediate air supply part 165 and the right air supply part 166 have the same structure as the left air supply part 164 and have the same functions.

Specifically, the intermediate air supply part 165 includes a main body 165A (FIG. 3) corresponding to the main body 164A, an air chamber 165B (FIG. 3) corresponding to the air chamber 164B, an air supply port 165C (FIG. 3) corresponding to the air supply port 164C, a connecting part (not shown. Hereinafter also referred to as connecting part 165D) corresponding to the connecting part 164D, and a gas flow path (not shown) corresponding to the gas flow path 164E (Hereinafter, also referred to as a gas flow path 165E). A second air supply pipe 182 to be described later is connected to the connecting part 165D.

The right air supply part 166 includes a main body 166A (FIG. 3) corresponding to the main body 164A, an air chamber 166B (FIG. 3) corresponding to the air chamber 164B, an air supply port 166C (FIG. 3) corresponding to the air supply port 164C, a connecting part (not shown. Hereinafter also referred to as connecting part 166D) corresponding to the connecting part 164D, and a gas flow path (not shown) corresponding to the gas flow path 164E (Hereinafter, also referred to as a gas flow path 166E). A third air supply pipe 183 to be described later is connected to the connecting part 166D.

The intake part 167 takes in air by suctioning gas on the lower side. The intake part 167 has a structure similar to the left air supply part 164 and the like (shape is different). The gas on the lower side includes, in addition to air, a solvent evaporated when drying the ink (also referred to as solvent vapor), and an ink mist which is a misted ink of the ink ejected from the inkjet head 162 (details will be described later). As shown in FIG. 3, the intake part 167 includes a main body 167A, an air chamber 167B, and an intake port 167C. The intake part 167 further includes a connecting part (not shown. Hereinafter, it is also referred to as a connecting part 167D) and a gas flow path (not shown. Hereinafter, it is also referred to as a gas flow path 167E).

The main body 167A has a cubic shape, and interiorly includes a cubic-shaped air chamber 167B, and the intake port 167C penetrating the main body 167A in the vertical direction is provided at the position of the lower surface (facing downward on the medium side). The intake port 167C extends along the sub scanning direction and communicates the air chamber 167B and the lower side of the intake part 167 (main body 167A). The connecting part 167D is provided in a convex shape on the far surface of the main body 167A, and is connected to an intake pipe 184 to be described later. The gas flow path 167E extends in the near-far direction (sub scanning direction), penetrates the main body 167A and the connecting part 167D, and communicates the air chamber 167B with the intake pipe 184.

As will be described later, the gas in the air chamber 167B is discharged from the air chamber 167B through the intake pipe 184 and the gas flow path 167E. As a result, the air chamber 167B becomes a negative pressure. Due to such a negative pressure, the gas on the lower side of the intake part 167 is taken in from the intake port 167C.

As shown in FIG. 3, the width of each of the air supply port 164C, the air supply port 165C, the air supply port 166C, and the intake port 167C (length along the near-far direction, that is, the length along the sub scanning direction) is wider than the head 162C, head 162M, head 162Y, and head 162K of the inkjet head 162 (particularly, length along the sub scanning direction from the nozzle on the near most side to the nozzle on the far most side among the plurality of nozzles that eject ink) (see FIG. 3).

The device main body 11 includes a first air supply device 171 to a third air supply device 173, a first air supply pipe 181 to a third air supply pipe 183, an air intake device 174, a collecting device 175, and an intake pipe 184 inside the housing 110, as shown in FIG. 5.

Each of the first air supply device 171 to the third air supply device 173 includes an air supply pump or a fan that blows air. One end of a first air supply pipe 181 is connected to the first air supply device 171. Similarly, one end of a second air supply pipe 182 is connected to the second air supply device 172. One end of a third air supply pipe 183 is connected to the third air supply device 173.

Each of the first air supply pipe 181 to the third air supply pipe 183 is configured by one or more hollow rubber or resin tubes having flexibility. The other end of the first air supply pipe 181 is connected to the left air supply part 164 (connecting part 164D). The other end of the second air supply pipe 182 is connected to the intermediate air supply part 165 (connecting part 165D). The other end of the third supply pipe 183 is connected to the right air supply part 166 (connecting part 166D).

The first air supply device 171 to the third air supply device 173 are immovable, while the left air supply part 164 to the right air supply part 166 are movable by the carriage 161. Since the first air supply pipe 181 to the third air supply pipe 183 have flexibility, the first air supply pipe 181 to the third air supply pipe 183 deform following the movement of the left air supply part 164 to the right air supply part 166.

The first air supply device 171 takes in surrounding gas and sends the taken-in gas into the first air supply pipe 181. Here, the surrounding gas may be a gas outside the housing 110 (in this case, the first air supply device 171 may be provided so as to penetrate the housing 110), or may be a gas inside the housing 110 (same for other air supply devices). The gas sent into the first air supply pipe 181 by the first air supply device 171 flows into the air chamber 164B through the first air supply pipe 181 and the gas flow path 164E in the left air supply part 164. As a result, the air chamber 164B becomes a positive pressure, and the gas in the air chamber 164B is sent downward (supplied) from the air supply port 164C. Thus, the left air supply part 164 supplies gas from the air supply port 164C to the lower side of the left air supply part 164 by the first air supply device 171.

The second air supply device 172 takes in surrounding gas and sends the taken-in gas into the second air supply pipe 182. The gas sent to the second air supply pipe 182 by the second air supply device 172 flows into the air chamber 165B through the second air supply pipe 182 and the gas flow path 165E of the intermediate air supply part 165. As a result, the air chamber 165B becomes a positive pressure, and the gas in the air chamber 165B is sent out (supplied) toward the lower side from the air supply port 165C. In this way, the intermediate air supply part 165 supplies gas from the air supply port 165C to the lower side of the intermediate air supply part 165 by the second air supply device 172.

The third air supply device 173 takes in surrounding gas and sends the taken-in gas into the third air supply pipe 183. The gas sent into the third supply pipe 183 by the third air supply device 173 flows into the air chamber 166B through the third air supply pipe 183 and the gas flow path 166E of the right air supply part 166. As a result, the air chamber 166B becomes a positive pressure, and the gas in the air chamber 166B is sent (supplied) toward the lower side from the air supply port 166C. Thus, the right air supply part 166 supplies gas from the air supply port 166C to the lower side of the right air supply part 166 by the third air supply device 173.

The intake device 174 includes an exhaust pump or a fan that performs exhaust. The collecting device 175 cools the gas passing through the collecting device 175 and collects predetermined components (here, solvent vapor and ink mist described later) from the gas. The intake pipe 184 is configured by one or more hollow rubber or resin tubes having flexibility and forms a gas flow path.

The intake device 174 is connected to the collecting device 175. One end of the intake pipe 184 is connected to the collecting device 175. The other end of the intake pipe 184 is connected to the connecting part 167D of the intake part 167.

The intake device 174 is immovable, while the intake part 167 can be moved by the carriage 161. Since the intake pipe 184 has flexibility, it deforms following the movement of the intake device 174.

The intake device 174 takes in the gas in the air chamber 167B of the intake part 167 through the collecting device 175, the intake pipe 184, and the gas flow path 167E, and controls the air chamber 167B to a negative pressure, thereby taking in surrounding gas (gas on lower side of intake part 167) of the intake port 167C from the intake port 167C. The gas taken in from the intake port 167C passes through the air chamber 167B, the gas flow path 167E, and the intake pipe 184, and thereafter passes through the collecting device 175, and finally passes through the intake device 174 and exhausted to the outside of the intake device 174. The gas taken in from the intake port 167C and passing through the collecting device 175 includes solvent vapor and ink mist, which will be described later, in addition to air. The collecting device 175 cools the gas, and collects the solvent vapor and ink mist by liquefying or aggregating them. The remaining air is discharged to the outside by the intake device 174.

The first air supply device 171 to the third air supply device 173 are immovable, while the left air supply part 164 to the right air supply part 166 are movable by the carriage 161. Since the first air supply pipe 181 to the third air supply pipe 183 have flexibility, the first air supply pipe 181 to the third air supply pipe 183 deform following the movement of the left air supply part 164 to the right air supply part 166.

As shown in FIG. 1, the inkjet printer 10 also includes a controller 190 and an operation panel 195 that control the entire inkjet printer 10.

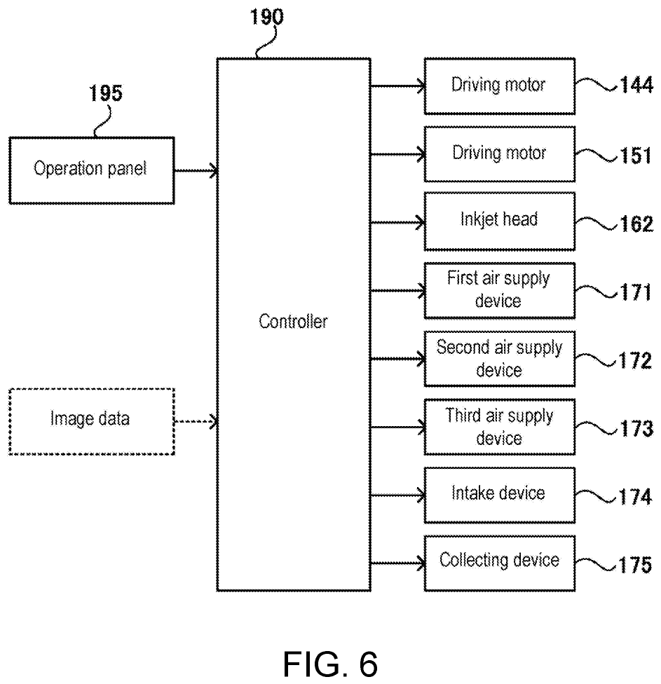

As shown in the block diagram of FIG. 6, the controller 190 controls the driving motor 144, the driving motor 151, the inkjet head 162, the first air supply device 171, the second air supply device 172, and the third air supply device 173, the intake device 174 and the collecting device 175. The controller 190 includes various computers such as a microcomputer that operates according to a program. The controller 190 can communicate with an external host computer or the like, and image data is provided to the controller 190.

The operation panel 195 includes a touch panel that receives an operation from the user. The operation panel 195 provides an operation signal indicating the content of the operation received from the user to the controller 190. The controller 190 controls each component based on the operation signal.

(Operation of inkjet printer 10)

The controller 190 receives image data provided from a host computer or the like, and performs a printing process (control of each component described above) based on the image data. The printing process may be started with an operation for starting printing on the operation panel 195 as a trigger. Hereinafter, this printing process will be described, but here, it is assumed that the medium M is set by a user or the like at a position where printing can be started.

In the printing process, the controller 190 first drives the driving motor 144, rotates the driving pulley 141, and moves the printing unit 160 to the right initial position. Thereafter, the controller 190 drives the driving motor 144, rotates the driving pulley 141, and moves the printing unit 160 from the right (initial position) to the left.

The controller 190 controls each of the heads 162C, 162M, 162Y, and 162K of the inkjet head 162 at a timing based on the image data while the printing unit 160 is moving from right to left, and ejects ink from these heads. During this movement, the controller 190 operates the fixing device 163 located on the back side (right side of FIG. 2) in the advancing direction of the inkjet head 162, irradiates the ink ejected (landed) on the medium M with ultraviolet lights, and dries (fixes) the ink. Through such a process, one line of the image represented by the image data is printed.

Thereafter, the controller 190 drives the driving motor 151, rotates the driving roller 152, feeds the medium M in the sub scanning direction by a predetermined amount, drives the driving motor 144, rotates the driving pulley 141, and moves it to the initial position of the printing unit 160.

Thereafter, the controller 190 drives the driving motor 144 to move the printing unit 160 from the right (initial position) to the left, and during the movement, controls each head 162C, 162M, 162Y, 162K of the inkjet head 162 at the timing based on the image data to eject ink from such heads. Furthermore, during the movement, the controller 190 operates the fixing device 163, irradiates the ink ejected onto the medium M with ultraviolet lights, and dries (fixes) the ink.

The controller 190 prints the image represented by the image data on the medium M by repeating the above.

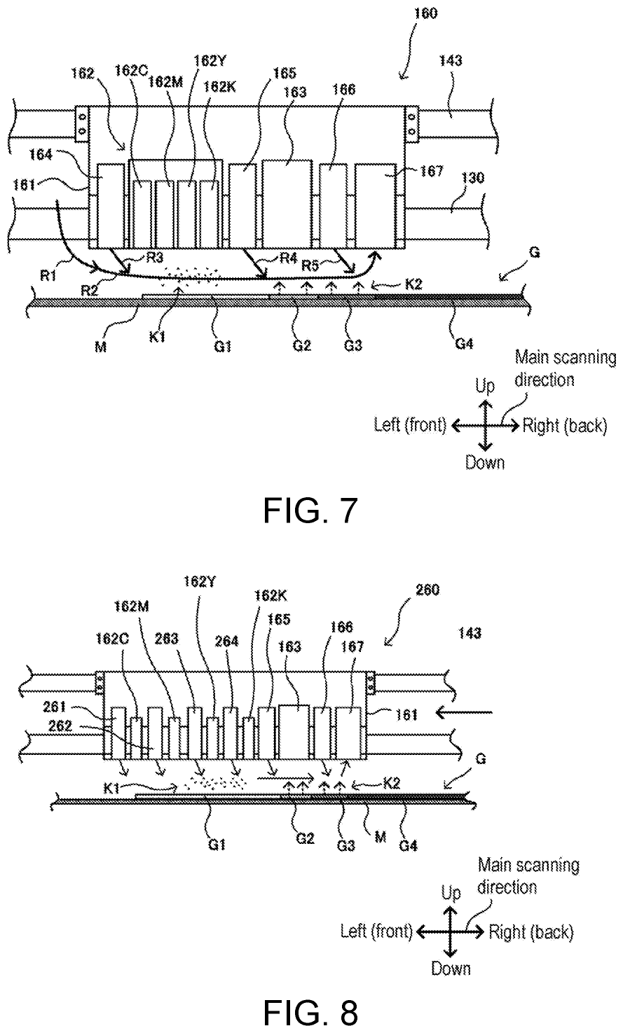

When printing is performed as described above, a part of the ink ejected from each head 162C, 162M, 162Y, and 162K of the inkjet head 162 is misted to become an ink mist (see the dot K1 in FIG. 7), and may drift through a space between the inkjet head 162 and the medium M. Furthermore, at the time of fixing (drying) the ink ejected on the medium M, the solvent of the ink (a part (component) of the ink ejected from the head 162C etc.) evaporates, and the solvent vapor which is the vapor of the solvent (see dotted line arrow K2 in FIG. 7) generates. In this embodiment, in order to prevent the ink mist and solvent vapor from adhering to unintended locations in the device main body 11, air intake by the intake part 167 and air supply by the left air supply part 164, and the like are performed.

Specifically, the controller 190 operates the intake device 174 while the printing unit 160 is moving from right to left (moving to eject ink), and causes the intake part 167 (intake port 167C) to take in air. At this time, the controller 190 also operates the collecting device 175 to liquefy or aggregate the solvent vapor and the ink mist (collected by the collecting device 175). Furthermore, the controller 190 operates the first air supply device 171 to the third air supply device 173 while the printing unit 160 is moving from right to left (moving to eject ink), and causes the left air supply part 164 (air supply port 164C), the intermediate air supply part 165 (air supply port 165C), and the right air supply part 166 (air supply port 166C) to supply air. The air supply and air intake are performed over the entire period during which the printing unit 160 is moving.

(Effects Etc. Of Air Intake and Air Supply)

The effects and the like of air intake by the intake part 167 and air supply by the left air supply part 164 will be described with reference to FIG. 7. In FIG. 7, the printing unit 160 (inkjet head 162 etc.) ejects ink while moving from right to left. In the following, the right is also referred to as the back side and the left is also referred to as the front side with the advancing direction of the printing unit 160 (inkjet head 162 etc.) as a reference.

The ink layer G in FIG. 7 is formed by droplet-like ink ejected in droplets from each of the heads 162C, 162M, 162Y, 162K of the inkjet head 162 moving from right to left and reaching (landing) the medium M. The ink layer G includes ink layers G1 to G4 having different degrees of drying. The ink ejected from each of the heads 162C, 162M, 162Y, and 162K is divided into droplet-like ink that lands on the medium M to form the ink layer G and ink mist (see the dot K1).

The ink layer G1 is a part of the ink layer G located on the front side of the fixing device 163. The ink layer G1 is not yet irradiated with ultraviolet lights from the fixing device 163. The ink layer G1 is thus not dried.

The ink layer G2 is a part of the ink layer G following the back side of the ink layer G1. The ink layer G2 is located below the fixing device 163 and is a part irradiated with ultraviolet lights from the fixing device 163. The ink layer G2 has a high temperature due to the irradiation of ultraviolet lights, and the evaporation of the ink solvent (see the dotted line arrow K2) has started.

The ink layer G3 is a part of the ink layer G following the back side of the ink layer G2. The ink layer G3 is located on the back side of the fixing device 163, and is a part immediately after the irradiation of ultraviolet lights from the fixing device 163 is terminated. The ink layer G3 still has a relatively high temperature due to the remaining heat after the irradiation of ultraviolet lights, and the evaporation of the ink solvent (see the dotted line arrow K2) is continued.

The ink layer G4 is a part of the ink layer G following the back side of the ink layer G3, and is a part that has been fixed on the medium M after the solvent of the ink has completely evaporated (the ink has dried).

The printing unit 160 pushes away the air in front by moving. A part of the air that has been pushed away goes around to the lower side of the printing unit 160 (see the airflow R1). The air that has moved to the lower side moves backward (right direction) between the printing unit 160 and the medium M relatively with respect to the printing unit 160 moving from right to left. That is, due to the movement of the printing unit 160, an airflow R2 relatively directed backward with respect to the moving printing unit 160 is generated between the printing unit 160 and the medium M. The printing unit 160 includes the intake part 167 at the end, and since the intake part 167 takes in air while the printing unit 160 is moving, the airflow R2 is eventually directed toward the intake part 167 (intake port 167C).

The ink mist (reference number K1) generated when ink is ejected from the inkjet head 162 is flowed in the airflow R2 to relatively move backward (right direction) with respect to the printing unit 160, and eventually taken in by the intake part 167.

The solvent (solvent vapor) evaporated from the ink layer G2 or the ink layer G3 (see the dotted line arrow K2) moves upward (the printing unit 160 side), but is flowed by the airflow R2 flowing over the ink layers G2 and G3, and thus is flowed backward and the solvent vapor is also eventually taken in by the intake part 167.

At the back side of the moving printing unit 160, the air pressure is lowered by the movement of the printing unit 160. Accordingly, if there is no intake part 167, the airflow R2 eventually goes around to the back side of the printing unit 160. In such a case, the ink mist or solvent vapor will be swung up to the back side of the printing unit 160 by the airflow going around to the back side of the printing unit 160, and may adhere to an unintended location (periphery of the printing unit 160, components in the device main body 11, the medium M, etc.) in the device main body 11 (the solvent vapor adheres after condensation Hereinafter, the same applies). In this embodiment, since the intake part 167 is provided at the end of the printing unit 160 (back side of the inkjet head 162 and the fixing device 163) to perform the intake, the ink mist and the solvent vapor are taken in by the intake part 167, so that the ink mist and the solvent vapor can be prevented from flowing in an unintended direction, and condensation due to aggregation of the solvent at the unintended location, adhesion of the solvent to the location due to the condensation, adhesion of the ink mist to the unintended location (ink mist is collected and adhered as ink), dropping of the adhered solvent or ink onto the medium M, and the like can be prevented.

Furthermore, since the solvent vapor and the ink mist can be collected by the collecting device 175, the solvent vapor and the ink mist can be prevented from being released into the atmosphere and the like, and an inkjet printer 10 that is friendly to the environment and the human body can be realized.

Moreover, in this embodiment, while the printing unit 160 is moving, the left air supply part 164 (air supply port 164C), the intermediate air supply part 165 (air supply port 165C), and the right air supply part 166 (air supply port) 166C) each sends out (supplies) gas (air) downward (here, in particular, downward in the vertical direction (direction orthogonal to the surface of the medium M). This air supply generates airflows R3 to R5. Specifically, the air supply from the left air supply part 164 generates an airflow R3, the air supply from the intermediate air supply part 165 generates an airflow R4, and the air supply from the right air supply part 166 generates an airflow R5.

The airflows R3 to R5 are directed downward and also relatively move in the right direction with respect to the moving printing unit 160. That is, the airflows R3 to R5 are relatively directed in the lower right direction (backward and downward) with respect to the printing unit 160. Such airflows R3 to R5 can prevent the airflow R2 from moving upward (direction approaching the printing unit 160, away from the medium M), and the airflows R3 to R5 move downward while involving the surrounding air, and thus the ink mist and the solvent vapor can be moved away from the printing unit 160, and they can be prevented from moving upward (i.e., moving toward the printing unit 160). In particular, the airflows R3 to R5 can prevent the upward movement of the ink mist, and the airflows R4 to R5 can prevent the upward movement of the solvent vapor. By preventing such movement, the ink mist and the solvent vapor can be efficiently guided to the intake part 167.

Since the airflows R3 to R5 prevent the upward movement of the ink mist and the solvent vapor, they can also be prevented from adhering particularly to the inkjet head 162 and the fixing device 163 of the printing unit 160. Thus, ink ejection failure of the inkjet head 162, color mixture of ink ejected from the inkjet head 162 and ink mist, irradiation failure of ultraviolet lights from the fixing device 163, and the like can be prevented. Furthermore, contamination of the medium M by ink mist, and the like can be prevented.

In the above configuration, the intake part 167 is located immediately after the right air supply part 166 (both are adjacent to each other as a set), so that the ink mist and the solvent vapor moved away from the printing unit 160 by the airflow R5 of the right air supply part 166 can be immediately taken in by the intake part 167, and the ink mist and the solvent vapor can be effectively prevented from adhering to an unintended location in the device main body 11. An intake part (similar to the intake part 167) for taking in air may be provided between the inkjet head 162 and the fixing device 163, such as immediately after the intermediate air supply part 165, but in this embodiment, the intake part 167 is provided only at the end (after all the air supply parts) and the intake part is not provided between the inkjet head 162 and the fixing device 163, and the like, so that the ink mist and the solvent vapor can be taken in by the intake part 167 at the end while arranging the intake part in the one intake part 167 at the end.

Furthermore, the respective width of the air supply port 164C, the air supply port 165C, the air supply port 166C, and the intake port 167C is wider than each width of the head 162C, the head 162M, the head 162Y, and the head 162K of the inkjet head 162, that is, the air supply port 164C and the like are wider in the sub scanning direction orthogonal to the main scanning direction (advancing direction of the printing unit 160) than the head 162C and the like, so the airflows R2 to R5 can be generated across the entire sub scanning direction of the head 162C and the like, and the upward movement of the ink mist and solvent vapor can be prevented and air intake can be performed efficiently.

### MODIFIED EXAMPLES

The present disclosure is not limited to the embodiment described above, and various modifications can be applied to the embodiment described above. Modified examples will be illustrated below, where the same reference numerals are denoted on components having the same function and the components corresponding to those in the embodiment described above.

### First Modified Example

As the instantaneous drying ink, that in which an ink component (e.g., solvent, coloring material, etc.) having an ultraviolet absorbing action may be used in addition to the ink added with an ultraviolet absorbent. The wavelength of the light (ultraviolet light) emitted from the LED lamp disposed in the fixing device 163 is preferably set to a wavelength within a range of 280 to 400 nm, which is substantially the same as the ultraviolet absorbent or the absorption wavelength in the ultraviolet absorbing action. In particular, an LED lamp capable of emitting ultraviolet lights having a wavelength in the range of 360 to 390 nm can output high power, and is preferably provided in the fixing device 163.

The instantaneous drying ink may contain an energy ray absorbent other than the ultraviolet absorbent or an ink component (e.g., solvent, coloring material, etc.) having an energy ray absorbing action other than the ultraviolet light. That is, the instantaneous drying ink may be any ink that contains a component that absorbs energy rays. Examples of energy rays include visible light and infrared lights. In this case, the ink is dried by emitting energy rays (infrared lights, visible light, etc.) corresponding to the energy ray absorption characteristics (wavelength band of absorbable electromagnetic waves, etc.) from the fixing device 163.

In the ink containing a component that absorbs energy rays, the solvent of the ink evaporates at one time by irradiation of the energy rays, but the evaporated solvent taken in by the intake part 167. Thus, the configuration in which the intake part 167 is provided as described above operates effectively when the ink contains a component that absorbs energy rays.

The ink ejected from the inkjet head 162 may be dried by heat from a heater. In this case, the fixing device 163 may be a heater or the like. Furthermore, in place of the fixing device 163, the medium M may be heated on the platen 120 side to dry the ink layer G. If the ink has high drying property, heating may be unnecessary. In this case, the fixing device 163 and the intermediate air supply part 165 and/or the right air supply part 166 can be omitted.

The ink ejected by the inkjet head 162 may be, other than each ink of YMCK, each ink of RGB, light color ink, white ink, pearl ink, metallic ink, clear ink (e.g., energy ray curable ink such as UV curable resin, etc. or an ink for forming a protective layer for protecting the surface (printing surface) of the medium M), and the like.

As ink ejected from the inkjet head 162, energy ray curable ink such as UV curable ink may be used in addition to the instantaneous drying ink. In this case, the printing unit 160 is provided with an emission device that emits an energy ray for curing the energy ray curable ink. When the instantaneous drying ink and the energy ray curable ink are used, the fixing device 163 may function as the emission device if the energy rays used for both are the same (e.g., the same wavelength band, etc.). For example, the energy ray curable ink may be ejected from the inkjet head 162 when moving in the left direction (outward path) and may be cured when moving in the right direction (return path) (irradiating energy rays in the return path). The energy ray curable ink ejected on to the medium M thus can be cured after flattening. In such a case, either an instantaneous drying ink and an energy ray curable ink in which the energy rays used for curing the curable ink are different are adopted (irradiate the energy ray curable ink in the outward path), or printing with the energy ray curable ink is performed after the printing with the instantaneous drying ink.

### Second Modified Example

The orientation of each of the air supply ports 164C to 166C of the left air supply part 164 to the right air supply part 166 is arbitrary, and for example, air supply for discharging gas toward the lower diagonally front side or the lower diagonally back side may be performed. The air supply ports 164C to 166C are, for example, formed to a slit shape so as not to generate turbulence on the lower side of the printing unit 160 so as not to hinder the flight of ink droplets ejected by inkjet, and a guide member for rectifying the discharged gas may be provided in the vicinity of each of the air supply ports 164C to 166C. Furthermore, the air supply ports 164C to 166C may be formed in a slit shape or a rectangular shape, and a structural object of a collection of tubular bodies (including a polygonal tube, a cylinder, etc.) such as a honeycomb structure may be disposed in the air supply ports 164C to 166C to rectify the gas.

The first air supply device 171 to the third air supply device 173 may be an ultrasonic blower, a device that supplies compressed gas from a cylinder, or the like (the air supply includes sending gas other than air). The first air supply device 171 to the third air supply device 173 may be combined into one air supply device, and gas may be supplied from the one air supply device to each of the left air supply part 164 to the right air supply part 166. Furthermore, the first air supply device 171 to the third air supply device 173 may be omitted, and various fans such as line flow fans (fans for air supply) and a motor for rotating the fan may be provided in each of the left air supply part 164 to the right air supply part 166. The orientation of each of the air supply ports 164C to 166C may be any orientation that can supply air in an arbitrary direction on the medium M side. In addition to the lower side, the medium side includes a lower diagonally front side or a lower diagonally back side (hereinafter the same).

The intake device 174 may be omitted, and various fans such as a line flow fan (fan for intake) and a motor for rotating the fan may be provided in the intake part 167. The orientation of the intake port 167C is arbitrary, and for example, may be an arbitrary direction on the medium M side. Furthermore, since the airflow R2 goes around to the back side of the printing unit 160 if the intake part 167 is not present, the orientation of the intake port 167C may be backward. Moreover, as long as the ink mist or solvent vapor can be taken in, the intake port 167 may be directed upward or forward to taken in the ink mist or solvent vapor.

### Third Modified Example

The arrangement of the air supply port is arbitrary. For example, as shown in FIG. 8, the inkjet head 260 may include air supply parts 261 to 264 similar to the left air supply part 164 in front of each of the heads 162C, 162M, 162Y, and 162K. The air supply part 261 is located in front of the head 162C, the air supply part 262 is located in front of the head 162C, the air supply part 263 is located in front of the head 162Y, and the air supply part 264 is located in the head 162K. With such an arrangement, the ink mist can be effectively prevented from adhering to each head by the air supply from the air supply parts 261 to 264.

The inkjet head 162 may include a head other than a head that ejects CMYK ink. For example, the inkjet head 162 may include each head that ejects each ink of RGB (head that ejects red ink, head that ejects green ink, head that ejects blue ink) in addition to or in place of each head 162C, 162M, 162Y, and 162K of CMYK. Thus, color rendering property can be improved, and ink smearing can be prevented.

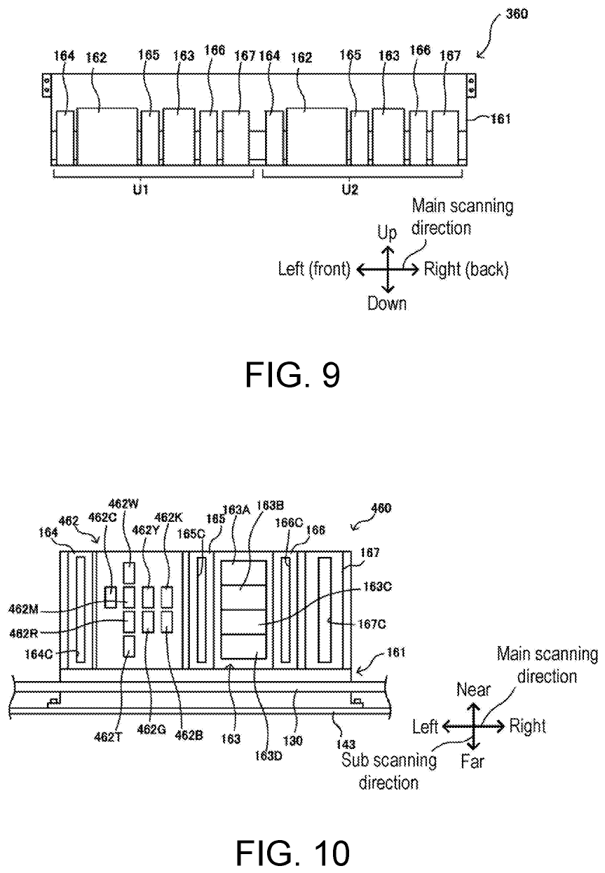

For example, as shown in FIG. 9, the inkjet head 360 may include two sets of units U1 and U2. Each of the units U1 and U2 includes an inkjet head 162, a fixing device 163, a left air supply part 164, an intermediate air supply part 165, a right air supply part 166, and an intake part 167. The two sets of units U1 and U2 are arranged in the left-right direction and mounted on the carriage 161. The inkjet heads 162 of the two sets of units U1 and U2 may have different inks to be ejected. For example, the inkjet head 162 of the unit U1 has a head that ejects each CMYK ink, and the inkjet head 162 of the unit U2 has a head that ejects an arbitrary ink other than CMYK, such as for example, RGB ink. With an air supply part and an intake part provided for each unit, mixing of ink mist generated in one unit with ink ejected by another unit, mixing of solvent vapor generated in one unit with ink ejected by another unit or mixing with solvent vapor of another unit, and the like can be prevented. Three or more units may be provided. For example, in order to represent intermediate colors well, a unit including an inkjet head 162 that ejects light-colored ink may be added. One unit may include an inkjet head 162 that ejects other inks such as clear ink.

### Fourth Modified Example

In the description made above, the heads of the inkjet head 162 are arranged in a line along the main scanning direction, but the arrangement of the heads is also arbitrary. For example, as shown in FIG. 10, a plurality of heads may be arranged in the sub scanning direction. The printing unit 460 of FIG. 10 includes an inkjet head 462. The inkjet head 462 includes, from the nearside direction, a head 462W that ejects white ink in the first column, heads 462C, 462M, 462Y, and 462K that eject each ink of CMYK in the second column, heads 462R, 462G, and 462B that eject each ink of RGB in the third column, and a head 462T that ejects pearl ink, metallic ink, clear ink, and the like in the fourth column. In addition, the heads that eject each ink of primary color (e.g., CMY) may be arranged in the first column, the heads that eject each color of secondary color (e.g., RGB) may be arranged in the second column, a head that ejects ink of tertiary color (e.g., K) may be arranged in the third column, and a head that ejects other ink may be arranged in the fourth row (this arrangement can prevent smearing of ink, etc.). The types of ink that can be ejected can be increased while suppressing the length of the inkjet head 162 in the main scanning direction by also arranging a plurality of heads in the sub scanning direction.

The fixing device 163 in FIG. 10 includes a plurality of fixing devices 163A to 163D arranged in the sub scanning direction. The fixing device 163A is disposed at a position corresponding to the head in the first column, and fixes the ink ejected from the head in the first column to the medium M (e.g., drying or curing by irradiating ultraviolet lights etc.). The fixing device 163B is disposed at a position corresponding to the head in the second column, and fixes the ink ejected from the head in the second column to the medium M (e.g., drying or curing by irradiating ultraviolet lights etc.). The fixing device 163C is disposed at a position corresponding to the head in the third column, and fixes the ink ejected from the head in the third column to the medium M (e.g., drying or curing by irradiating ultraviolet lights etc.). The fixing device 163D is disposed at a position corresponding to the head in the fourth column, and fixes the ink ejected from the head in the fourth column to the medium M (e.g., drying or curing by irradiating ultraviolet lights etc.). Thus, by corresponding each of the plurality of fixing devices 163A to 163D disposed along the sub scanning direction to the heads of each column, the mode of each of the fixing devices 163A to 163D (type of energy ray, whether it is a heater, etc.) can be made different, and ink corresponding to each mode can be arranged in each column. This increases the types of ink that can be employed.

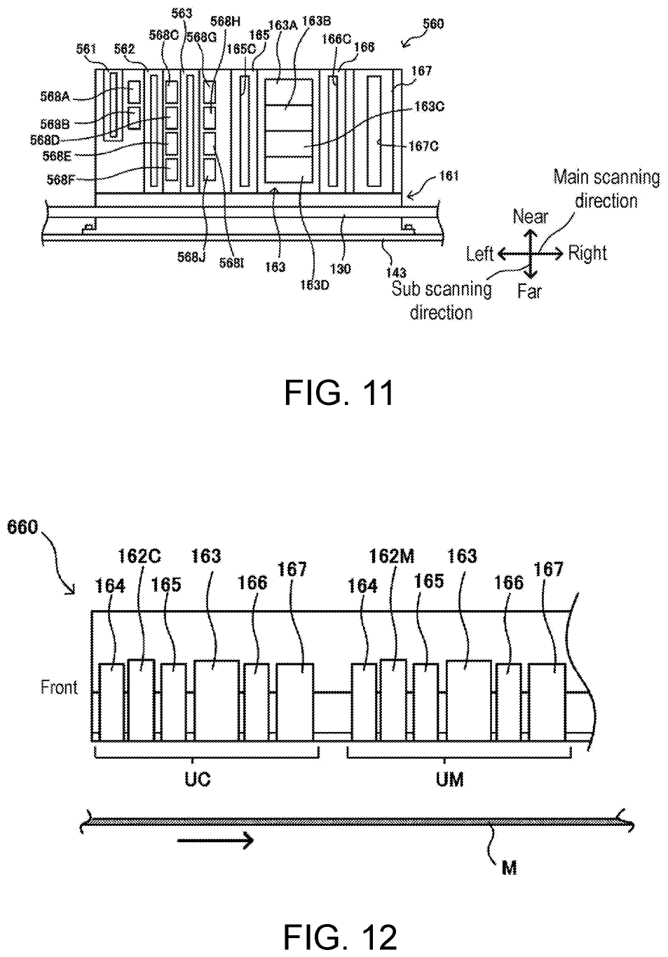

The printing unit 560 shown in FIG. 11 may include air supply parts 561 to 563 on the left side (front side in the advancing direction) of each of the set of heads arranged in the sub scanning direction, similar to the example of FIG. 8. The air supply part 561 is disposed on the left side of the heads 568A and 568B. The air supply part 562 is disposed on the left side of the heads 568C to 568F. The air supply part 563 is disposed on the left side of the heads 568G to 568J. The air supply parts 561 to 563 have the same configuration as the air supply part 164 and the like. The width of each of the air supply part 561 to 563 is longer than the total widths of the plurality of heads on the right side (here, the length from the head on the near most side to the head on the far most side), but if the width of the head on the right side is short, it is accordingly made shorter (e.g., the air supply part 561 has a narrower width than the air supply part 562 etc.). Such a configuration can prevent unnecessary airflow from being generated. The widths of the intermediate air supply part 165, the right air supply part 166, the intake part 167, and the like are wider than the total of the longest widths in each column. Thus, ink mist and solvent vapor can be effectively guided to the intake part 167, and can be taken in by the intake part 167. The ink mist can be effectively prevented from adhering to each head by the air supply from the air supply parts 561 to 563.

### Fifth Modified Example

The present disclosure is also applicable to a line printer. In this case, as in the printing unit 660 of FIG. 12, a fixing device 163, a left air supply part 164 to a right air supply part 166, and an intake part 167 are preferably provided for each head that ejects each ink of CMYK. The printing unit 660 of FIG. 12 includes a unit UC including a head 162C that ejects cyan ink, a fixing device 163, a left air supply part 164 to a right air supply part 166, and an intake part 167; a unit UM including a head 162M that ejects magenta ink, a fixing device 163, a left air supply part 164 to a right air supply part 166, and an intake part 167; a unit UY (not shown) including a head 162Y that ejects yellow ink, a fixing device 163, a left air supply part 164 to a right air supply part 166, and an intake part 167; and a unit UK (not shown) including a head 162K that ejects black ink, a fixing device 163, a left air supply part 164 to a right air supply part 166, and an intake part 167. In the line printer, the printing unit 660 does not move in the main scanning direction, and the medium M moves in the sub scanning direction. That is, the printing unit 660 relatively moves in the sub scanning direction with respect to the medium M (left side in the plane of drawing in FIG. 12 is the front side in the moving direction). Even in such a printing unit 660, solvent vapor and ink mist can be taken in by the intake parts 167 of the units UC, UM, UY, and UK. In particular, since the ink layer formed by the ink ejected from each unit moves toward the back side in the relative moving direction of the printing unit 660, solvent vapor can be supplied by the intake part 167 in each unit. Furthermore, it is possible to suppress, to some extent, the solvent vapor and ink mist from move upward by the air supply from the left air supply part 164 to the right air supply part 166 of each unit. To effectively guide the solvent vapor and the ink mist to the intake part 167 by the air supply from the left air supply part 164 to the right air supply part 166, the orientation of each air supply port 164C to 166C of the left air supply part 164 to the right air supply part 166 may be set toward the diagonally lower side heading toward the back side in the relative moving direction. That is, the air supply ports 164C to 166C may discharge gas backward and diagonally downward. The unit UC, unit UM, unit UY, and unit UK may be configured as separate housings. Furthermore, a unit for ejecting other ink may be provided.

The present disclosure is also applicable to sign graphics printers, textile printers, industrial printers, 3D printers, various solution (expressed as ink) applying machines, and the like.

### Sixth Modified Example

The inkjet printer 10 merely needs to include, for example, an intake part 167 disposed on the back side of various heads such as the inkjet head 162 (back side in the relative moving direction with respect to the medium), and an arbitrary air supply part such as the left air supply part 164 may be omitted. Thus, the ink mist and the solvent vapor can be taken in, and can be prevented from adhering to an unintended location. The ink may be that in which components other than the solvent are evaporated by the fixing device 163 or the like (intake part 167 merely needs to take in various components evaporated from the ink). Ideally, it is preferable to employ an inkjet head 162 or the like that does not generate ink mist. In this case, the intake part 167 only needs to be able to take in various components evaporated from the ink.

What is claimed is:

1. An inkjet printer comprising:
an inkjet head that ejects an ink onto a medium through an inkjet method when moving relative to the medium in a predetermined direction; and
an intake part that is disposed on a back side of the inkjet head in the predetermined direction and that takes in air while moving relative to the medium in the predetermined direction together with the inkjet head.

2. The inkjet printer according to claim 1, wherein
the intake part takes in an evaporated component of components of the ink ejected from the inkjet head onto the medium.

3. The inkjet printer according to claim 1, wherein
the intake part takes in a misted ink that is mist of the ink ejected from the inkjet head.

4. The inkjet printer according to claim 2, wherein
the intake part takes in a misted ink that is mist of the ink ejected from the inkjet head.

5. The inkjet printer according to claim 1, further comprising:
a first air supply part that is disposed on a front side of the inkjet head in the predetermined direction and that supplies air toward a side of the medium while moving relative to the medium in the predetermined direction together with the inkjet head.

6. The inkjet printer according to claim 2, further comprising:
a first air supply part that is disposed on a front side of the inkjet head in the predetermined direction and that supplies air toward a side of the medium while moving relative to the medium in the predetermined direction together with the inkjet head.

7. The inkjet printer according to claim 3, further comprising:
a first air supply part that is disposed on a front side of the inkjet head in the predetermined direction and that supplies air toward a side of the medium while moving relative to the medium in the predetermined direction together with the inkjet head.

8. The inkjet printer according to claim 4, further comprising:
a first air supply part that is disposed on a front side of the inkjet head in the predetermined direction and that supplies air toward a side of the medium while moving relative to the medium in the predetermined direction together with the inkjet head.

9. The inkjet printer according to claim 1, further comprising:
a second air supply part that is disposed between the inkjet head and the intake part and that supplies air toward a side of the medium while moving relative to the medium in the predetermined direction together with the inkjet head, wherein
the second air supply part and the intake part are disposed adjacent to each other in the predetermined direction.

10. The inkjet printer according to claim 2, further comprising:
a second air supply part that is disposed between the inkjet head and the intake part and that supplies air toward a side of the medium while moving relative to the medium in the predetermined direction together with the inkjet head, wherein
the second air supply part and the intake part are disposed adjacent to each other in the predetermined direction.

11. The inkjet printer according to claim 3, further comprising:
a second air supply part that is disposed between the inkjet head and the intake part and that supplies air toward a side of the medium while moving relative to the medium in the predetermined direction together with the inkjet head, wherein
the second air supply part and the intake part are disposed adjacent to each other in the predetermined direction.

12. The inkjet printer according to claim 4, further comprising:
a second air supply part that is disposed between the inkjet head and the intake part and that supplies air toward a side of the medium while moving relative to the medium in the predetermined direction together with the inkjet head, wherein
the second air supply part and the intake part are disposed adjacent to each other in the predetermined direction.

13. The inkjet printer according to claim 5, further comprising:
a second air supply part that is disposed between the inkjet head and the intake part and that supplies air toward a side of the medium while moving relative to the medium in the predetermined direction together with the inkjet head, wherein
the second air supply part and the intake part are disposed adjacent to each other in the predetermined direction.

14. The inkjet printer according to claim 1, further comprising:
a drying device that is disposed between the inkjet head and the intake part, and that moves relative to the medium in the predetermined direction together with the inkjet head to dry the ink ejected from the inkjet head onto the medium.

15. The inkjet printer according to claim 14, wherein
the ink contains an energy ray absorbing component that absorbs energy rays and generates heat,
the drying device irradiates the ink ejected onto the medium with the energy rays to heat the energy ray absorbing component and dry the ink, and
the intake part takes in a component evaporated when drying the ink.

16. The inkjet printer according to claim 14, further comprising:
a third air supply part that is disposed between the drying device and the intake part, and that supplies air toward a side of the medium while moving relative to the medium in the predetermined direction together with the inkjet head, wherein
the third air supply part and the intake part are disposed adjacent to each other along the predetermined direction.

17. The inkjet printer according to claim 15, further comprising:
a third air supply part that is disposed between the drying device and the intake part, and that supplies air toward a side of the medium while moving relative to the medium in the predetermined direction together with the inkjet head, wherein
the third air supply part and the intake part are disposed adjacent to each other along the predetermined direction.

18. The inkjet printer according to claim 16, further comprising:
a fourth air supply part that is disposed between the inkjet head and the drying device, and that supplies air toward the side of the medium while moving relative to the medium in the predetermined direction together with the inkjet head.

19. The inkjet printer according to claim 17, further comprising:
a fourth air supply part that is disposed between the inkjet head and the drying device, and that supplies air toward the side of the medium while moving relative to the medium in the predetermined direction together with the inkjet head.
